(19) United States
(12) Patent Application Publication
(10) Pub. No.: US 2015/0343517 A1
(43) Pub. Date: Dec. 3, 2015

(54) Blade Manufacturing Methods and Blanks of Blades

(71) Applicant: LDW Real Estate Inc, Ponderay, ID (US)

(72) Inventor: Lucas David Webster, Sandpoint, ID (US)

(73) Assignee: LDW Real Estate Inc, Ponderay, ID (US)

(21) Appl. No.: 14/293,715

(22) Filed: Jun. 2, 2014

(51) Int. Cl. B21D 53/64; B24C 1/04; B23P 15/28; B23H 9/00

(52) U.S. Cl. CPC B21D 53/645; B23H 9/00; B24C 1/045; B23P 15/28

(57) ABSTRACT

Counter-reliefs of faces of blanks of blades are machined in flat stock sheets of steel with a precision provided by the machining and without producing thermal damage (i.e., overheating) and/or chatter marks on the surface of the blanks of the blades. The blanks of the blades are separated from the flat stock sheet of steel and quickly and easily finished to a quality equal to a quality of handmade cottage industry blades.

### BACKGROUND

Making hollow-ground blades can be a slow paced, laborious, and precise process in which manufacturers grind out a blade one at a time. This is particularly true for straight razors, where the manufacturer creates a hollow in a blade of the straight razor by hand. There are only a handful cottage industry manufactures capable of making straight razors having an extreme level of quality not found in any other straight razors. To date, there has been no satisfactory way of mass producing hollow ground blades.

As manufacturing technology has evolved, higher quantities of straight razor blades can be constructed with higher levels of quality. For instance, straight razors can now be made by first cutting a profile of a blade from flat stock steel plate and then hollow grinding the flat stock profiles by hand or by machine (e.g., a computer numerical control (CNC) machine). In the case of the hollow grind being produced by hand, the level of quality of the hollow ground blade may be higher than the quality of the hollow ground blade produced by machine, but the quantity and repeatability of the hollow ground blades produced may be lower than the quantity of hollow ground blades produced by machine.

In the case of the hollow grind being produced by machine, the level of quality of the hollow ground blade may be lower than the quality of the blade produced by hand, but the quantity and repeatability of hollow ground blades produced may be higher than the quantity of hollow ground blades produced by hand. The quality of the hollow grind produced by machining may be lower, for example, because of heat damage and/or chatter marks caused by the machine.

In another example, straight razors can now be made by stamping (e.g., hot stamping) a hollow blade from steel. Such stamped hollow blades may then be finished by hand. The level of quality of the stamped hollow blade may be lower than the quality of the blade produced by machining, but the quantity of the hot stamped hollow blades produced may be higher than the quantity of hollow ground blades produced by machining. For example, because the stamping process may not be as precise as the machining process, the stamping process may produce discontinuities or irregularities in the surface of the blade resulting in a lower quality of a blade than a quality of a blade produced by machine grinding a profile of a blade. Moreover, the stamping process may produce bent blades, which require a laborious manual process to straighten the bent blades.

Accordingly there remains a need in the art for a method of manufacturing blades at higher quantities than by hand, while still having the same or better level of quality as handmade cottage industry blades.

### SUMMARY

This summary is provided to introduce simplified techniques for producing straight razors and other blades as described further in the Detailed Description. This summary is not intended to identify essential features of the claimed subject matter, nor is it intended for use in determining the scope of the claimed subject matter.

In one example, a method includes cutting counter-reliefs of first and second faces of a blank of a blade in first and second planar sides of a plate before separating the blank of the blade from the plate. In some instances, the counter-relief of the second face of the blank of the blade in the second planar side of the plate may be cut symmetrically with the counter-relief of the first face of the blank of the blade cut in the first planar side of the plate. The method may also include removing the blank of the blade from the plate after cutting the counter-reliefs of first and second faces of the blank of the blade in the plate.

In another example, a plate having a first planar side opposite a second planar side includes a counter-relief of a first face of the blank of the blade cut in the first planar side of the plate and a counter-relief of a second face of the blank of the blade cut in the second planar side of the plate. A counter-relief as used herein is a face of a blank of a blade arranged in a plate and produced by removing material from the plate. The counter-reliefs of the first and second faces of the blank of the blade may include the features that form the blade. For example, the counter-reliefs of the first and second faces of the blank of the blade may include a non-cutting surface (e.g., a surface of a back or a spine of the blade) and a cutting surface (e.g., a surface of a cutting edge or cutting portion of the blade). The first non-cutting surface of the blank of the blade may be left uncut and may include the first planar side of the plate and the second non-cutting surface of the blank of the blade be left uncut and may include the second planar side of the plate. The first cutting surface of the blank of the blade may be cut a depth below the first non-cutting surface of the blank of the blade and the second cutting surface of the blank of the blade may be cut a depth below the second non-cutting surface of the blank of the blade. A bevel may be cut between the cutting surface and the non-cutting surface. The bevel cut between the cutting surface and the non-cutting surface may be a hollow bevel cut between the cutting surface and the non-cutting surface.

These techniques may be used to mass produce high quality blades. Further, these techniques may be used to produce high quality blades having hollow grinds. For example, these techniques may be used to produce counter-reliefs of first and second faces of blanks of blades in a plate of material that include hollow grinds of the blades. Further, these techniques may be used to form multiple blanks of blades in a plate of material.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIGS. 1A, 1B, and 1C illustrate counter-reliefs of first and second faces of blanks of blades cut in first and second planar sides of a plate.

FIG. 2 illustrates a detail view of the counter-reliefs of the first and second faces of the blanks of the blades cut in the first and second planar sides of the plate shown in FIGS. 1B and 1C with broken lines.

FIG. 3 illustrates a perspective view of the counter-reliefs of the first and second faces of the blanks of the blades cut in the first and second planar sides of the plate shown in FIG. 1 with a blank of a blade separated from the plate.

FIG. 4 illustrates a detail view of the blank of the blade separated from the plate shown in FIG. 3.

FIG. 5 illustrates an example process for manufacturing the counter-reliefs of the first and second faces of the blanks of the blades cut in the first and second planar sides of the plate shown in FIG. 1.

### DETAILED DESCRIPTION

### Overview

This disclosure is directed to methods of manufacturing blades and, in particular, manufacturing high quality blades in large quantities and with high repeatability. As discussed above, there has been no satisfactory way of mass producing hollow ground blades. This is because when high quantities are involved, the methods used to produce the blades can result in lower quality blades. For example, a quality of a blade produced by machining may be lower because the step of cutting the features (e.g., cutting edges, hollows, backs or spines, tangs, etc.) of the blade is performed subsequent to the cutting of the profile of the blade from a sheet of material. Because the step of cutting the features of the blade is performed subsequent to the step of cutting the profile of the blade from the sheet of material, the high levels of friction produced between the machine and the profile of the blade during the cutting of the features of the blade may generate excess heat, and damage the blade.

To produce high quality blades in large quantities and with repeatability, manufacturing the high quality blades may involve cutting counter-reliefs of blanks of blades in a plate prior to the step of cutting the blanks of the blades from the plate. Because the step of cutting the counter-reliefs of the blanks of the blades is performed prior to the step of cutting the blanks of blades from the plate, the high levels of friction produced between the machine and the plate during the cutting of the counter-reliefs of the blanks of blades does not generate excess heat, and does not damage the blades.

In some examples, a machine (e.g., a computer numerical control (CNC) machine) may cut counter-reliefs of blanks of blades in flat stock sheets. For example, the machine may cut a first set of counter-reliefs in a first planar side of a flat stock sheet opposite a second planar side of the flat stock sheet. The second planar side of the flat stock sheet may be mounted flat on a fixture (e.g., a tombstone) as support for cutting the first set of counter-reliefs in the first planar side. Subsequent to the cutting of the first set of counter-reliefs, the flat stock sheet may be unmounted from the fixture and remounted on the fixture with the first planar side of the flat stock sheet now mounted flat on the fixture. For example, the uncut portion of the first planar side of the flat stock sheet arranged around the first set of counter-reliefs may be mounted flat on the fixture to provide for cutting a second set of counter-reliefs in the second planar side of the flat stock sheet. Stated otherwise, the uncut portion of the first planar side of the flat stock sheet arranged around the first set of counter-reliefs may be mounted flat on the fixture as support for cutting the second set of counter-reliefs in the second planar side of the flat stock sheet. Moreover, the counter-reliefs of the blanks of the blades may be cut in the flat stock sheet such that the counter-reliefs remain attached to the flat stock sheet to provide support for cutting the counter-reliefs of the blanks of the blades. For example, the second set of counter-reliefs in the second planar side of the flat stock sheet may be cut symmetrically with the first set of counter-reliefs in the first planar side of the flat stock sheet such that a cutting portion of the blank of the blade has a minimum thickness and remains attached to a portion (e.g., a non-cutting portion of an adjacent blank of a blade) of the flat stock sheet.

In this way, the machine may cut a plurality of blanks of blades nested in the flat stock sheet with the precision provided by the machine and without producing thermal damage (i.e., overheating) and/or chatter marks on the surface of the blanks of the blades. Nested blank of blades as used herein is a plurality of blanks of blades machined in a flat stock sheet such that the plurality of blanks of blades remain attached to the flat stock sheet. A blank of a blade as used herein is a blank that has features (e.g., cutting edges, hollows, backs or spines, tangs, etc.) of the blade that were previously cut in the flat stock sheet prior to the removal of the blank from the flat stock sheet, and the removed blank only needs to have cosmetic machine marks removed and sharpened.

Because a machine may cut a plurality of blanks of blades nested in the flat stock sheet with the precision provided by the machine without producing thermal damage (i.e., overheating) and/or chatter marks on the surface of the blanks of the blades, or without bending (e.g., deforming) the blank of the blades, the plurality of blanks of blades may be separated from the flat stock sheet and finished to a quality equal to a quality of handmade cottage industry blades. For example, because the blanks of the blades are machined with precision without thermal damage and/or chatter marks, or without bending the blank of the blades, the blanks of the blades only need to be separated from the flat stock sheet to simply remove cosmetic machine marks from the surfaces of blanks of the blades and to quickly and easily sharpen the cutting portions of the blanks of the blades.

In another example, the counter-reliefs of the blanks of the blades in the flat stock sheets may include a bevel. For example, the counter-reliefs of the blanks of the blades may include a bevel arranged between a non-cutting surface and a cutting surface of the blanks of the blades. For example, the bevel may be machine cut in the first planar side and/or the second planar side of the flat stock sheet between the non-cutting surface of the blanks of the blades and the cutting surface of the blanks of the blades. In one example, the bevel may be a hollow bevel. In another example, the bevel may be a flat bevel.

In other examples, separated blanks of blades may include first and second faces that may include non-cutting surfaces of the blade and cutting surfaces of the blade. The non-cutting surfaces of the blade may be uncut portions of the first or second planar sides of the flat stock sheets. For example, a first non-cutting surface of the blade may be uncut portions of the first planar side of the flat stock sheet used to provide support for cutting the second set of counter-reliefs in the second planar side of the flat stock sheet. For example, the first non-cutting surface of the blade may be a surface formed of, and coplanar to, the first planar side of the flat stock sheet used to provide for mounting the first planar side of the flat stock sheet on the fixture as support for cutting the second set of counter-reliefs in the second planar side of the flat stock sheet. The cutting surfaces of the blade may be cut a depth below the non-cutting surfaces of the blade. For example, a first cutting surface of the blade may be a bevel cut (e.g., a hollow grind or flat grind), cut below the first non-cutting surface of the blade, and a second cutting surface of the blade may be a bevel cut (e.g., a hollow grind or flat grind), cut below the second non-cutting surface of the blade symmetrically with the first cutting surface of the blade.

### Illustrative Nested Blanks of Blades

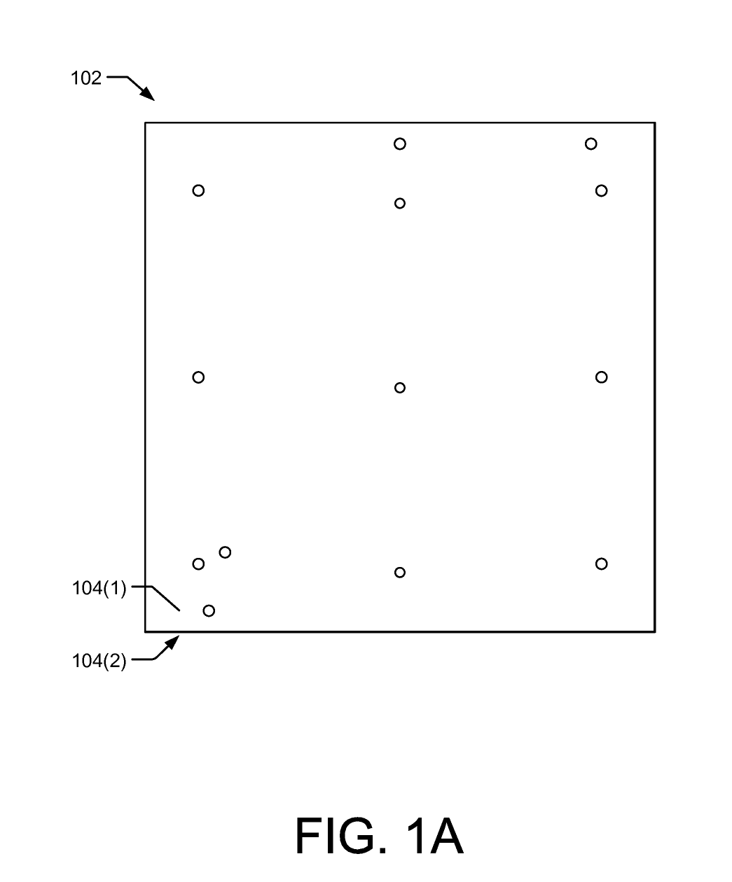

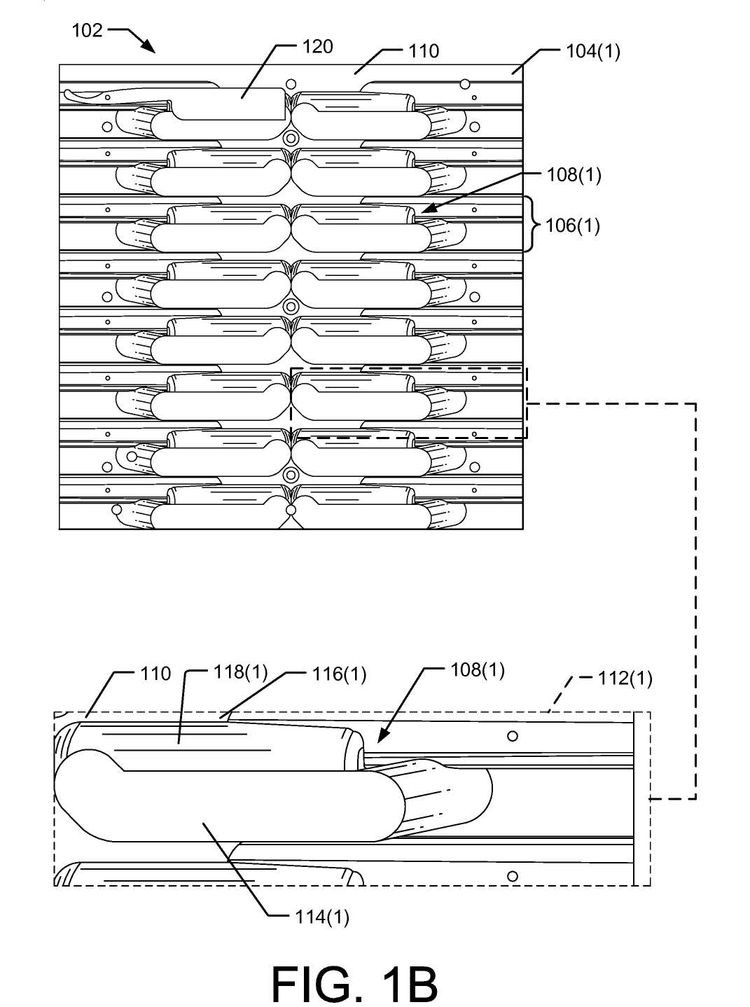

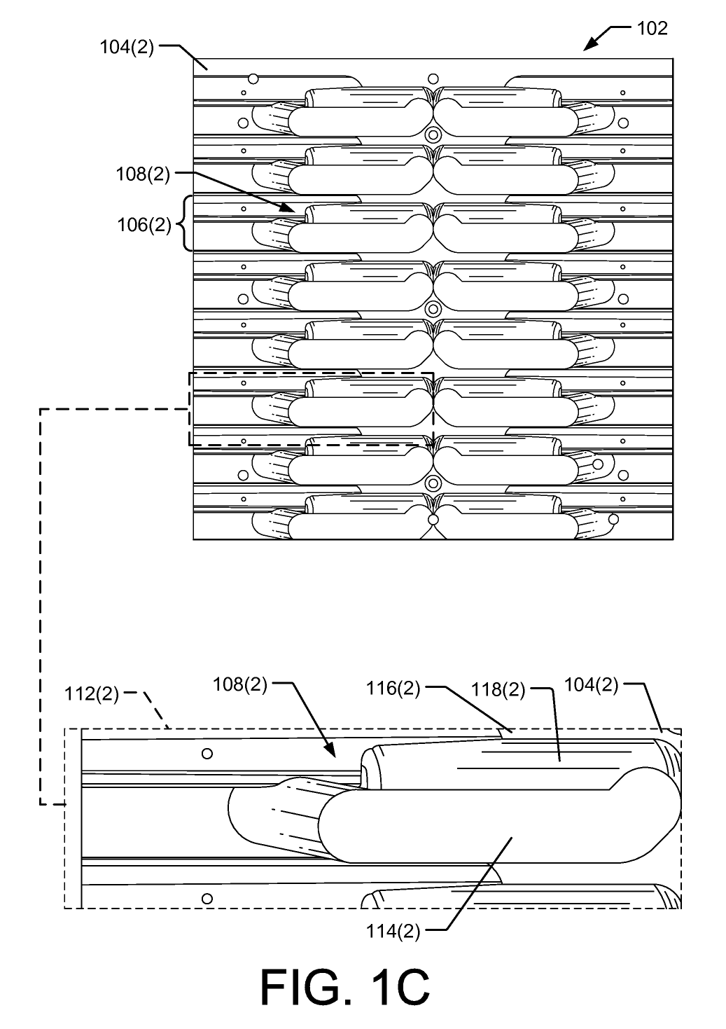

FIG. 1A illustrates a plate 102 having a first planar side 104(1) opposite a second planar side 104(2). FIG. 1B illustrates one or more counter-reliefs 106(1) may be cut in the first planar side 104(1) of the plate 102. For example, FIG. 1B illustrates a machine may cut the counter-reliefs 106(1) of first faces of blanks of blades 108(1) in the first planar side 104(1) of the plate 102. In some examples, the plate 102 may be a flat ground stock sheet of metal (e.g., flat ground stock sheet of steel, stainless steel, titanium, stainless steel and titanium composite, etc.). The plate 102 may be mounted flat on a fixture (e.g., a tombstone), and a computer numerical control (CNC) machine (e.g., a horizontal mill) may cut the counter-reliefs 106(1) of the first faces of blanks of blades 108(1) in the first planar side 104(1) of the plate 102. In some examples, at least about 16 blanks of blades to at most about 64 blanks of blades may be cut in a plate. In some examples, the plate 102 may include mounting apertures to provide for mounting to the fixture. While FIG. 1A illustrates a rectangular shaped plate, the plate 102 may have any shape. For example, the plate 102 may comprise a substantially curvilinear or polygonal shaped profile. Further, while FIG. 1A illustrates the plate 102 having a length of about 12 inches (30 centimeters), a width of about 12 inches, and a thickness of about 0.3 inches (0.6 centimeters), the plate 102 may be any size. For example, the plate 102 may have a length up to at most about 36 inches (91 centimeters), a width up to at most about 36 inches, and a thickness up to at most about 2 inches (5 centimeters). In another example, the plate 102 may have a length of about 24 inches (60 centimeters), a width of about 24 inches, and a thickness of about 1 inch (2.5 centimeters).

FIG. 1C illustrates one or more counter-reliefs 106(2) of second faces of blanks of blades 108(2) may be cut in the second planar side 104(2) of the plate 102. For example, a machine may cut the counter-reliefs 106(2) of the second faces of blanks of blades 108(2) in the second planar side 104(2) of the plate 102 symmetrically with the one or more counter-reliefs 106(1) of the first faces of blanks of blades 108(1) cut in the first planar side 104(1) of the plate 102. In one example, subsequent to the cutting of the one or more counter-reliefs 106(1) of first faces of blanks of blades 108(1) cut in the first planar side 104(1) of the plate 102, the plate 102 may be unmounted from the fixture and remounted on the fixture with the first planar side 104(1) of the plate 102 now mounted flat on the fixture. For example, an uncut portion 110 of the first planar side 104(1) of the plate 102 arranged around the one or more counter-reliefs 106(1) may be mounted substantially flat on the fixture to provide for cutting the one or more counter-reliefs 106(2) of the second faces of blanks of blades 108(2) in the second planar side 104(2) of the plate 102. Stated otherwise, the uncut portion 110 of the first planar side 104(1) of the plate 102 arranged around the one or more counter-reliefs 106(1) may be mounted flat on the fixture as support for cutting the one or more counter-reliefs 106(2) in the second planar side 104(2) of the plate 102.

FIG. 1B illustrates a detail view 112(1) of a counter-relief 106(1) of a first face of a blank of blade 108(1) cut in the first planar side 104(1) of the plate 102, and FIG. 1C illustrates a detail view 112(2) of a counter-relief 106(2) of a second face of a blank of blade 108(2) cut in the second planar side 104(2) of the plate 102. Detail view 112(1) illustrates a first cutting surface 114(1) of the first face of the blank of the blade 108(1) may be cut in the first planar side 104(1) of the plate 102. The first cutting surface 114(1) of the first face of the blank of the blade 108(1) may be cut in the first planar side 104(1) of the plate 102 a distance from a first non-cutting surface 116(1) of the blank of the blade 108(1).

The first non-cutting surface 116(1) of the first face of the blank of the blade 108(1) may comprise the first planar side 104(1) of the plate 102, and the first cutting surface 114(1) of the first face of the blank of the blade 108(1) may be cut a depth below the first non-cutting surface 116(1) of the first face of the blank of the blade 108(1). For example, the first non-cutting surface 116(1) of the first face of the blank of the blade 108(1) may be substantially the same surface forming the uncut portion 110 of the first planar side 104(1) of the plate 102, and the first cutting surface 114(1) may be cut a depth below the uncut portion 110 of the first planar side 104(1) of the plate 102. Moreover, because the non-cutting surface 116(1) may be substantially the same surface, and thus coplanar to the first planar side 104(1) of the plate 102, the non-cutting surface 116(1) may be used to provide for mounting the first planar side 104(1) of the plate 102 on the fixture as support for cutting the second set of counter-reliefs 106(2) in the second planar side 104(2) of the plate 102.

Detail view 112(2) illustrates a second cutting surface 114(2) of the second face of the blank of the blade 108(2) may be cut in the second planar side 104(2) of the plate 102. The second cutting surface 114(2) of the second face of the blank of the blade 108(2) may be cut in the second planar side 104(2) of the plate 102 a distance from a second non-cutting surface 116(2) of the second face of the blank of the blade 108(2). Similar to the first non-cutting surface 116(1) of the first face of the blank of the blade 108(1), the second non-cutting surface 116(2) of the second face of the blank of the blade 108(2) may comprise the second planar side 104(2) of the plate 102. For example, an uncut portion of the second planar side 104(2) of the plate 102 may be arranged around the one or more counter-reliefs 106(2), and the second non-cutting surface 116(2) of the second face of the blank of the blade 108(2) may comprise the uncut portion of the second planar side 104(2). The second cutting surface 114(2) of the second face of the blank of the blade 108(2) may be cut a depth below the second non-cutting surface 116(2) of the second face of the blank of the blade 108(2).

Because the first and second cutting surfaces 114(1) and 114(2) of the blanks of the blades may be cut to a depth below the first and second non-cutting surfaces 116(1) and 116(2) of the blanks of the blades, and may remain attached to the plate 102 (e.g., remain attached to an adjacent blank of a blade), the machine may cut the one or more counter-reliefs 106(1) and 106(2) in the plate 102 with the precision provided by the machine. Moreover, because the first and second cutting surfaces 114(1) and 114(2) of the blanks of the blades may remain attached to the plate 102, the machine may cut the one or more counter-reliefs 106(1) and 106(2) in the plate 102 without producing thermal damage (i.e., overheating) and/or chatter marks on the first and second faces of the blanks of the blades 108(1) and 108(2). This is because, until now, a planar profile of a blade has been cut from a planar plate, and subsequently machined to produce a bevel (e.g., a hollow, a wedge, a chisel) in the first and second planar surfaces of the planar profile of the blade. Thus, an operator may take a considerable amount of time to mount a planar profile of the blade to a fixture (e.g., tombstone) and machine grind bevels in the planar profile of the blade. Moreover, because of the lack of material to support the planar profile of the blade during grinding, the machine may over heat the planar profile of the blade and/or produce chatter marks on the surface of the blade, damaging the blade and reducing a quality of the blade.

Because the machine may cut the one or more counter-reliefs 106(1) and 106(2) in the plate 102 with the precision provided by the machine, each of the plurality of the blanks of the blades may have substantially similar qualities. For example, because the blanks of blades may be CNC machined in the plate, each of the blanks of the blades may have a thickness at any given point on the blanks of the blades that varies from about 0.02 of an inch (0.05 of a centimeter) up to at most about 0.04 of an inch (0.1 of a centimeter). Moreover, the first and second faces of the blanks of the blades may be parallel to each other within 0.01 of an inch (0.02 of a centimeter). For example, the first and second cutting surfaces 114(1) and 114(2) of each of the blank of the blades may be parallel to each other within 0.01 of an inch (0.02 of a centimeter). In another example, the first and second non-cutting surfaces 114(1) and 114(2) of each of the blanks of blades may be substantially parallel within 0.01 of an inch (0.02 of a centimeter). Further, the thickness of each of the blanks of the blades may be centered on a middle of the blanks of the blades within 0.005 of an inch (0.01 of a centimeter). Thus, because a CNC machine may cut the one or more counter-reliefs 106(1) and 106(2) in the plate 102 with the precision provided by the CNC machine, each of the blanks of the blades may have substantially similar qualities about equal to a level of quality as handmade cottage industry blades. Moreover, because a CNC machine may cut a plurality of counter-reliefs 106(1) and 106(2) in the plate 102 in a small amount of time (e.g., about 10 minutes per plate), a high quantity of the blanks of the blades (e.g., at least about 16 blanks of blades and up to at most about 32 blanks of blades) may be produced in a small amount of time having the quality provided via the CNC machining.

Detail view 112(1) illustrates, the cutting of the counter-relief 106(1) of the first face of the blank of the blade 108(1) may also include cutting a bevel 118(1) between the first cutting surface 114(1) of the blank of the blade and the first non-cutting surface 116(1) of the blank of the blade. Detail view 112(2) illustrates, the cutting of the counter-relief 106(2) of the second face of the blank of the blade 108(2) may also include cutting a bevel 118(2) between the second cutting surface 114(2) of the blank of the blade and the second non-cutting surface 116(2) of the blank of the blade. In some examples, the cutting of the bevel 118(1) may comprise cutting a hollow bevel between the first cutting surface 114(1) of the blank of the blade and the first non-cutting surface 116(1) of the blank of the blade. Further, the cutting of the bevel 118(2) may also comprise cutting a hollow bevel between the second cutting surface 114(2) of the blank of the blade and the second non-cutting surface 116(2) of the blank of the blade. For example, the cutting of the hollow bevels may comprise cutting about a 16 degree hollow bevel between the first cutting surface 114(1) of the blank of the blade and the first non-cutting surface 116(1) of the blank of the blade, and/or cutting about a 16 degree hollow bevel between the second cutting surface 114(2) of the blank of the blade and the second non-cutting surface 116(2) of the blank of the blade. For example, the blank of the blade may comprise a blank of a straight razor blade, and the hollow bevels may be 16 degree hollow bevels cut between the first and second cutting surfaces 114(1) and 114(2) and the first and second non-cutting surfaces 116(1) and 116(2) of the blank of the blade to provide a comfortable shaving straight razor blade. In some examples where the blank of the blade may comprise a blank of a straight razor blade, an aperture may be machined in the plate 102 associated with each blank of a blade. For example, a cylindrical hole may be drilled through the plate proximate to a tang portion of the blank of the blade to provide for pinning the blade to scales or a handle of a straight razor.

In some examples, the cutting of the bevel 118(1) may comprise cutting a flat bevel between the first cutting surface 114(1) of the blank of the blade and the first non-cutting surface 116(1) of the blank of the blade. Further, the cutting of the bevel 118(2) may also comprise cutting a flat bevel between the second cutting surface 114(2) of the blank of the blade and the second non-cutting surface 116(2) of the blank of the blade. For example, the blank of the blade may comprise a blank of a knife (e.g., a butcher knife, a chef's knife, a pocket knife, a hunting knife, a utility knife, a medical knife, etc.), and the flat bevels may comprise a substantially wedge shaped profile or a substantially chisel shaped profile. In another example, the blank of the blade may comprise a blank of a shearing blade (e.g., grooming scissors, medical scissors, sewing scissors, agriculture scissors, kitchen scissors, etc.), and the flat bevels may comprise a substantially wedge shaped profile or a substantially chisel shaped profile.

While FIGS. 1B and 1C illustrate counter-reliefs 106(1) and 106(2) machined in the plate 102 to provide for cutting a straight razor blade profile 120 in the plate 102 to separate or remove straight razor blades from the plate 102, the counter-reliefs 106(1) and 106(2) may be machined in the plate to provide for cutting any type of blade profiles in the plate 102. For example, the counter-reliefs 106(1) and 106(2) may be machined in the plate 102 to provide for cutting profiles of a knife blade profile, a scissor blade profile, a utility blade profile, etc.

FIG. 2 illustrates a detail view 200 of the counter-reliefs 106(1) and 106(2) of the first and second faces of the blanks of the blades 108(1) and 108(2) cut in the first and second planar sides 104(1) and 104(2) of the plate 102 shown in FIGS. 1B and 1C with broken lines. Detail view illustrates the counter-reliefs 106(1) of the first faces of the blank of blades 108(1) may be symmetric with the counter-reliefs 106(2) of the second faces of the blanks of the blades 108(2). For example, the second set of counter-reliefs 106(2) in the second planar side 104(2) of the plate 102 may be cut symmetrically with the first set of counter-reliefs 106(1) in the first planar side 104(1) of the plate 102 such that a cutting portion 202 of a blank of a blade 204 has a minimum thickness 206 and remains attached to a non-cutting portion 208 of an adjacent blank of a blade 210.

The first planar side 104(1) may be substantially parallel to the second planar side 104(2), and the first and second planar sides 104(1) and 104(2) may be substantially symmetric about a centerplane 212 of the plate 102. In some examples, the second faces of the blank of the blades 108(2) may be mirror images of the first faces of the blank of the blades 108(1) about the centerplane 212. For example, the first and second faces of the blanks of the blades 108(1) and 108(2) may be symmetrically cut relative to each other about the centerplane 212. Stated another way, the first and second faces of the blanks of the blades 108(1) and 108(2) may be symmetrically cut about the centerplane 212 as mirror images.

In one example, the first cutting surface 114(1) of the first face of the blank of the blade 108(1) may be cut a depth below the first planar side 104(1) of the plate 102 such that the first cutting surface 114(1) may be arranged a distance 214 from the centerplane 212. For example, the first cutting surface 114(1) of the first face of the blank of the blade 108(1) may be cut a depth below the first planar side 104(1) of the plate 102, and separated the distance 214 of about 0.02 inches (0.05 centimeters) from the centerplane 212.

In some examples, the second cutting surfaces 114(2) of the second faces of the blanks of the blades 108(2) may be symmetrically cut about the centerplane 212 as mirror images of the first cutting surfaces 114(1) of the first faces of the blanks of the blades 108(2). For example, the second cutting surface 114(2) of the second face of the blank of the blade 108(2) may be cut a depth below the second planar side 104(2) of the plate 102 such that the second cutting surface 114(2) may be arranged the distance 214 from the centerplane 212. Further, the second cutting surface 114(2) may be cut in the second planar side 104(2) such that the second cutting surface 114(2) has substantially the same geometric shape as the first cutting surface 114(1). For example, the second cutting surface 114(2) may be cut in the second planar side 104(2) via the same cutting tool used to cut the first cutting surface 114(1), via the same cutting path as the cutting path used to cut the first cutting surface 114(1), and/or via the same cutting program used to cut the first cutting surface 114(1).

In some examples, the first and second cutting surfaces 114(1) and 114(2) may define and constitute the cutting portions 202 of the blanks of the blades. For example, the first and second cutting surfaces 114(1) and 114(2) may be arranged the distance 214 from the centerplane 212, such that the first and second cutting surfaces 114(1) and 114(2) may be separated by the minimum thickness 206 of about 0.040 inches (1 centimeter) to provide for sharpening the blank of the blade subsequent to the blank of the blade being separated or removed from the plate 102.

Moreover, the first and second cutting surfaces 114(1) and 114(2) may be cut a depth below the first and second planar sides 104(1) and 104(2) of the plate 102 such that the first and second cutting surfaces 114(1) and 114(2) may remain attached to the non-cutting portion 208 of the adjacent blank of the blade 210 to provide for cutting the second cutting surfaces 114(2) of the blanks of the blades. For example, because the first cutting surface 114(1) remains attached to the non-cutting portion 208 of the adjacent blank of the blade 210, the first cutting surface 114(1) may be displaced a smaller distance during a cutting (e.g., machining) of the second cutting surface 114(2) than if the first cutting surface 114(1) was not attached to the non-cutting portion 208 of the adjacent blank of the blade 210. Stated otherwise, because the first cutting surface 114(1) remains attached to the non-cutting portion 208 of the adjacent blank of the blade 210, the first cutting surface 114(1) may comprise at least a portion of a bridge and support the second cutting surface 114(2) of the blank of the blade during the cutting of the second cutting surface 114(2) above the first cutting surface 114(1).

Because the first cutting surfaces 114(1) remain attached to the non-cutting portions of the adjacent blanks of blades, a machine (e.g., a CNC machine) may cut the counter-reliefs 106(2) of the second faces of blanks of blades 108(2) in the second planar side 104(2) of the plate 102 with the precision provide by the machine because the first cutting surfaces 114(1) deform only a small distance during the machining of the second cutting surfaces 114(2). Moreover, because the first cutting surfaces 114(1) deform only a small distance during the machining of the second cutting surfaces 114(2), the machining does not produce thermal damage (i.e., overheating) and/or chatter marks on the surface of the blanks of the blades.

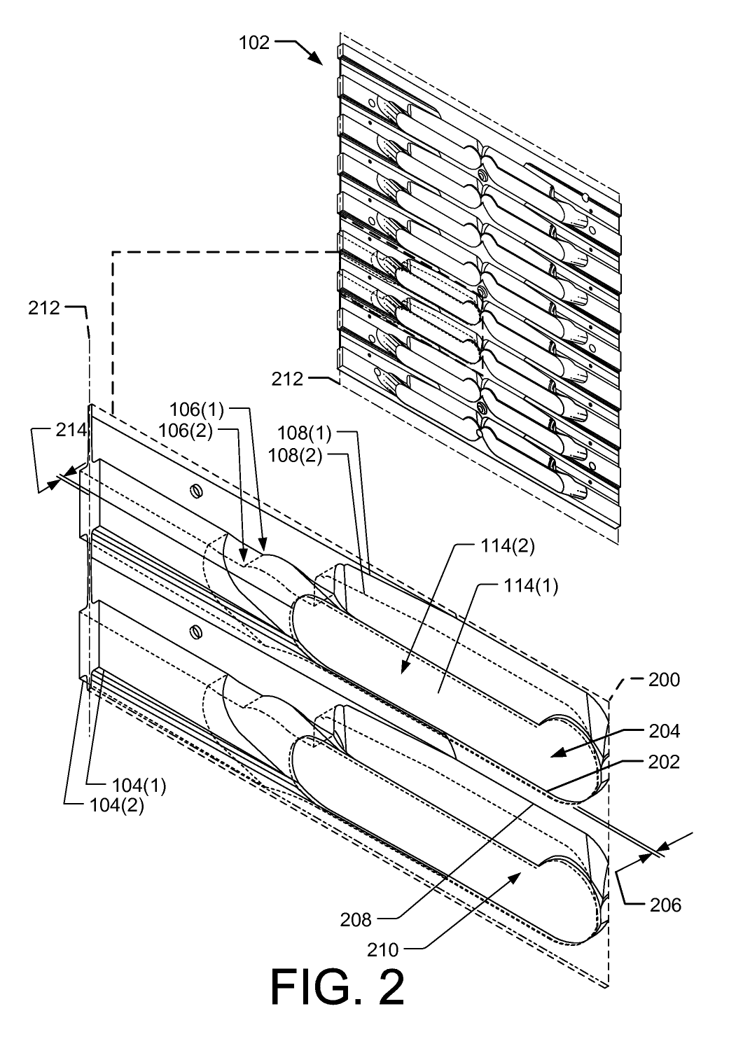

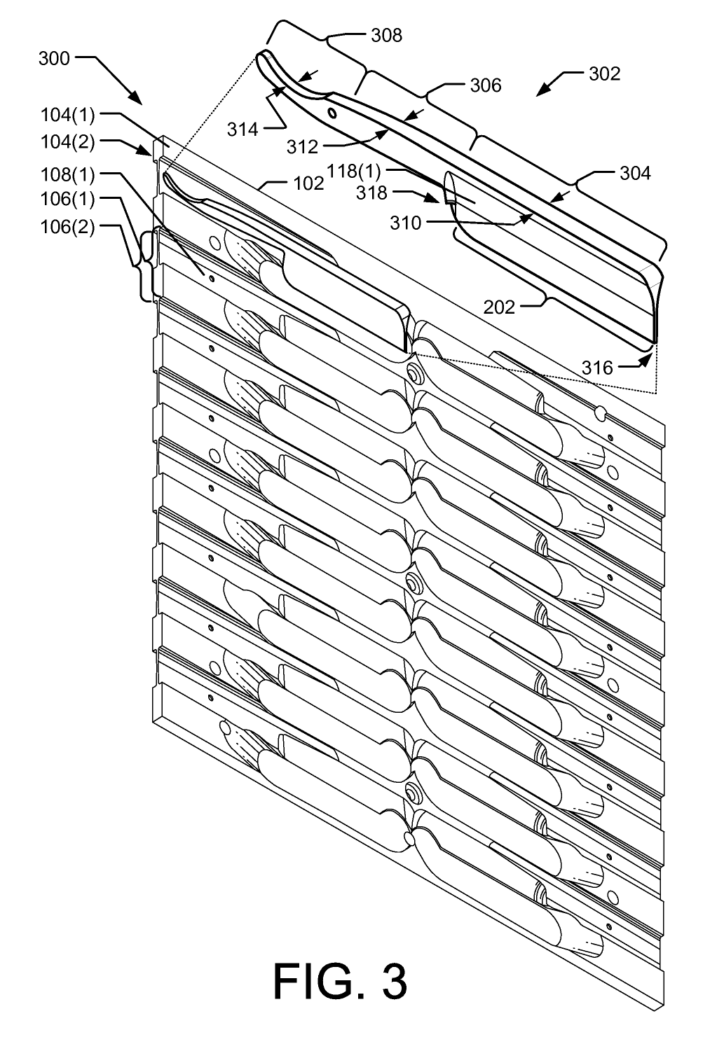

FIG. 3 illustrates a perspective view 300 of the counter-reliefs 106(1) and 106(2) of the first and second faces of the blanks of the blades 108(1) and 108(2) cut in the first and second planar sides 104(1) and 104(2) of the plate 102 shown in FIGS. 1B and 1C with a blank of a blade 302 separated from the plate 102.

Subsequent to the machining of the counter-reliefs 106(1) and 106(2) of first and second faces of blanks of blades 108(1) and 108(2) in the plate 102, the blanks of the blades 302 may be separated or removed from the plate 102 and quickly and easily finished and/or sharpened to a quality about equal to a quality of handmade cottage industry blades. In some examples, the blanks of the blades 302 may be separated from the plate 102 via a water jet. In some examples the blanks of the blades 302 may be separated or removed from the plate via cutting the blanks of the blades 302 from the plate 102, stamping the blanks of the blades 302 from the plate 102, electric discharge machining (EDM) the blanks of the blades 302 from the plate 102, computer numerical control (CNC) machining the blanks of the blades 302 from the plates 102, etc. Because the first and second faces of blanks of blades 108(1) and 108(2) are machined with precision without thermal damage and/or chatter marks, the separated blanks of blades 302 may simply require removal of cosmetic machine marks from the surfaces of blanks of blades. Subsequent to the removal of the cosmetic machine marks from the surfaces of the blanks of the blades 302, the blanks of the blades 302 may be heat treated. Moreover, because the blanks of the blades 302 are machined with precision without thermal damage and/or chatter marks, the cutting portion 202 of the separated blanks of blades 302 may be easily sharpened.

In some examples, the first planar side 104(1) or the second planar side 104(2) of the plate 102 may be mounted flat on a fixture, and a water jet CNC machine may cut the plate around the blank of blades 302 to separate the blank of blades 302 from the plate 102. In some examples, solid models may be utilized by the water jet CNC machine to cut the plate around the blank of blades 302. For example, a solid model used to machine the counter-reliefs 106(1) and 106(2) of first and second faces of blanks of blades 108(1) and 108(2) in the plate 102 may be used by a water jet CNC machine to cut the plate around the blank of the blades. In some examples, the water jet CNC machine may include a compensator to provide for cutting varying thicknesses of the plate around the blank of blades 302. For example, the counter-reliefs 106(1) and 106(2) of the first and second faces of the blanks of the blades 108(1) and 108(2) may have profiles that vary in thicknesses (e.g., thick to thin), and the compensator may compensate for the varying thickness as the water jet cuts the plate around the blanks of the blades. For example, the non-cutting portions 208 of the blank of blades 302 may have a back 304, a shank 306, and/or a tang 308. The back 304 having a thickness 310 thicker than a thickness 312 of the shank 306 and a thickness 314 of the tang 308. The compensator of the water jet CNC machine compensates for the thickness 310 of the back 304, the thickness 312 of the shank 306, and/or the thickness 314 of the tang 308 as the water jet CNC machine cuts the plate around the blank of blades 302. The water jet machine may provide for cutting substantially straight lines along the perimeter of the blank of the blade 302. Because the water jet CNC machine cuts the plate around the blank of the blades 302 with the precision provided by the water jet CNC machine, the blanks of the blades 302 are separated or removed from the plate 102 having a level of quality where the separated blanks of blades 302 may simply require removal of cosmetic machine marks and/or sharpening. For example, cosmetic surface blemishes on the first and second faces of the blanks of the blades 108(1) and 108(2) may only need to be buffed out, and the cutting portion 202 of the blanks of the blades may only need to be sharpened.

While FIG. 3 illustrates the blank of the blade 302 having a substantially rectilinear shaped head 316 and a substantially curvilinear shaped heel 318, the blank of blades 302 may have different shaped heads, heels, and/or profiles. For example, the blades may have substantially curvilinear shaped heads and curvilinear shaped heals, curvilinear shaped heads and rectilinear shaped heals, rectilinear shaped heads and rectilinear shaped heals. Further, while FIG. 3 illustrates the blank of the blade 302 having 16 degree bevels 118(1) and 118(2) arranged from the cutting portion 202 (e.g., cutting edge) to the back 304 of the blank of the blade 302, the bevels 118(1) and 118(2) may comprise any degree. For example, the bevels may be at least about 8 degree bevels to at most about 24 degree bevels arranged from the cutting portion 202 to the back 304 of the blade 302. Further, the bevels 118(1) and 118(2) may be flat bevels arranged from the cutting portion 202 to the back 304 of the blade 302.

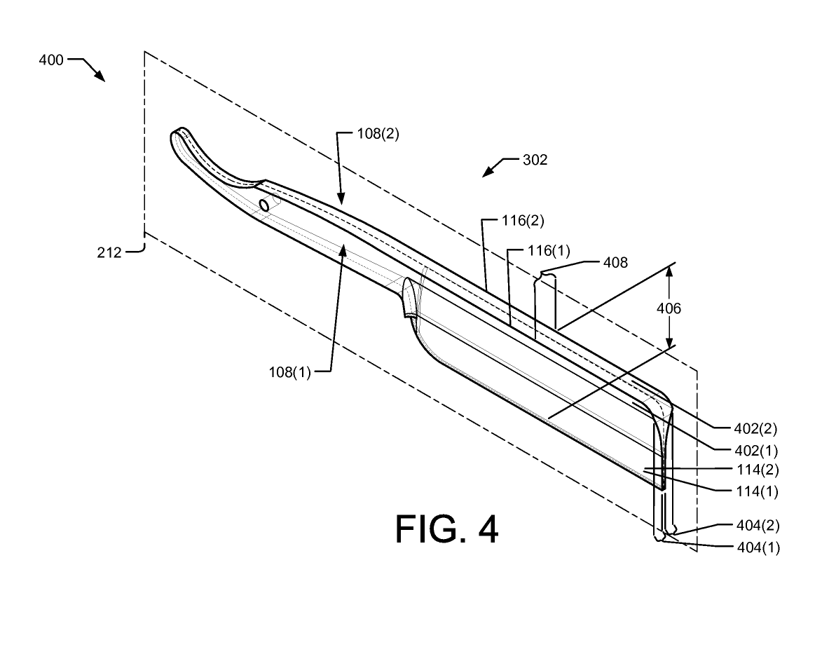

FIG. 4 illustrates a detail view 400 of the blank of the blade 302 separated from the plate 102 shown in FIG. 3. Detail view 400 illustrates the first and second faces 108(1) and 108(2) of the blank of the blade 302 may be substantially symmetric about the centerplane 212 of the plate 102. The first face of the blank of the blade 108(1) may include the first non-cutting surface 116(1) of the blank of the blade 302 and the second face of the blank of the blade 108(2) may include the second non-cutting surface 116(2) of the blank of the blade 302. The first non-cutting surface 116(1) of the blank of the blade 302 may include a portion 402(1) of the first planar side 104(1) of the plate 102, and the second non-cutting surface 116(2) of the blank of the blade 302 may include a portion 402(2) of the second planar side 104(2) of the plate 102. For example, the portion 402(1) of the first planar side 104(1) of the plate 102 may be substantially the same surface forming the uncut portion 110 of the first planar side 104(1) of the plate 102, and the portion 402(2) of the second planar side 104(2) of the plate 102 may be substantially the same surface forming the uncut portion 110 of the second planar side 104(2) of the plate 102.

Detail view 400 illustrates the first cutting surface 114(1) of the blank of the blade 302 may be cut a depth 404(1) below the first non-cutting surface 116(1) of the blank of the blade 302, and the second cutting surface 114(2) of the blank of the blade 302 may be cut a depth 404(2) below the second non-cutting surface 116(2) of the blank of the blade 302. The depths 404(1) and 404(2) of the cuts may be dependent on a size and/or shape of the blades. For example, because the bevels 118(1) and 118(2) may need to be about 16 degree bevels arranged from the cutting portion 202 (e.g., cutting edge) to the back 304 of the blank of the blades, a width 406 of the blank of the blades 302 and a thickness 408 of the blank of the blades 302 may range in size. For example, because the bevel may need to be about a 16 degree bevel to provide a comfortable shave, a blank of a blade having a width of about 0.6 inches (1.5 centimeters) may require a back of the blade having a thickness of about 0.2 inches (0.5 centimeters). Thus, in the example where the blank of the blade may have a thickness of about 0.2 inches (0.5 centimeters), the depths of the cuts below the non-cutting surfaces may be about 0.08 inches (0.2 centimeters). The depth of a cut is equal to the thickness of the blank of the blade (i.e., the thickness of flat ground steel sheet) divided by two, minus the minimum thickness 206 of the cutting portion of the blank of the blade (i.e., about 0.040 inches (1 centimeter)) divided by two. In another example, because the bevel may need to be about a 16 degree bevel, a blank of a blade having a width of about 0.8 inches (2 centimeters) may require a back of the blade having a thickness of about 0.3 inches (0.8 centimeters). Thus, in the example where the blank of the blade may have a thickness of about 0.3 inches (0.8 centimeters), the depths of the cuts below the non-cutting surfaces may be about 0.1 inches (0.3 centimeters). In another example, because the bevel may need to be about a 16 degree bevel, a blank of a blade having a width of about 1.5 inches (4 centimeters) may require a back of the blade having a thickness of about 0.6 inches (1.5 centimeters). Thus, in the example where the blank of the blade may have a thickness of about 0.6 inches (1.5 centimeters), the depths of the cuts below the non-cutting surfaces may be about 0.3 inches (0.8 centimeters).

Because the thickness of the back of the blade may be dependent on a width of the blade, a plurality of plates 102 having different thicknesses may be required. For example, the plate 102 may be a flat ground stock plate of steel having a thickness of about 0.2 inches (0.5 centimeters) to provide for making a blank of a blade having a width of about 0.6 inches (1.5 centimeters) and a thickness of about 0.2 inches (0.5 centimeters). In another example, the plate 102 may be a flat ground stock plate of steel having a thickness of about 0.3 inches (0.8 centimeters) to provide for making a blank of a blade having a width of about 0.8 inches (2 centimeters) and a thickness of about 0.3 inches (0.8 centimeters). In another example, the plate 102 may be a flat ground stock plate of steel having a thickness of about 0.6 inches (1.5 centimeters) to provide for making a blank of a blade having a width of about 1.5 inches (4 centimeters) and a thickness of about 0.6 inches (1.5 centimeters).

### Example Process for Manufacturing Blades

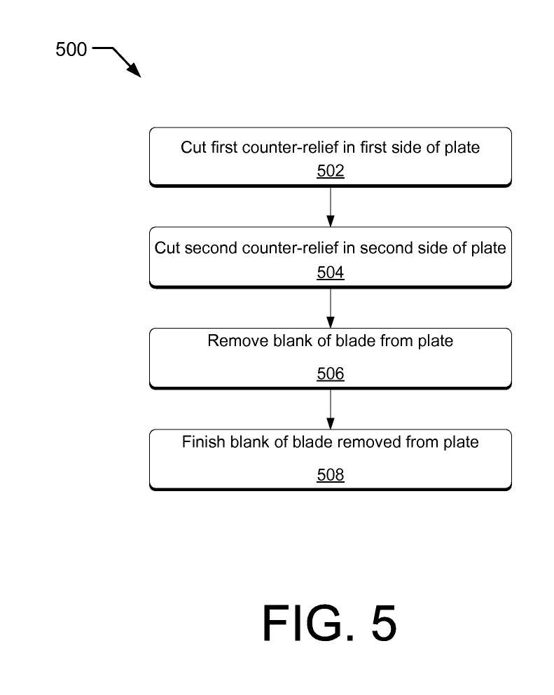

FIG. 5 illustrates an example process 500 for manufacturing blades having a quality equal to a quality of handmade cottage industry blades. For instance, this process may be performed to manufacture a plurality of blanks of blades nested in flat stock sheets (e.g., flat ground stock sheets of stainless steel). In some instances, the plurality of blanks of blades may be separated from the flat stock sheets and finished to a quality equal to a quality of handmade cottage industry blades. In some instances, the process may be performed at a manufacturing facility and prior to an assembly of a cutting unit (e.g., a straight razor, a pocket knife, a butcher knife, a chef's knife, a hunting knife, a utility knife, a medical knife, grooming scissors, medical scissors, sewing scissors, agriculture scissors, kitchen scissors, etc.). While FIG. 5 illustrates a process for manufacturing large quantities of blades having a quality equal to a quality of a handmade cottage industry blade, this process may apply to the manufacturing of any type of blade. Additionally, this process may apply to manufacturing any type of blade formed of any other materials capable of being machine ground.

Process 500 includes an operation 502, which represents cutting a counter-relief (e.g., counter-relief 106(1)) of a first face of a blank of a blade (e.g., first face of a blank of a blade 108(1)) in a first planar side (e.g., first planar side 104(1)) of a plate (e.g., plate 102) opposite a second planar side (e.g., second planar side 104(2)) of the plate. In some instances, the second planar side of the plate may be mounted on a fixture (e.g., a tombstone) as support for cutting the first set of counter-reliefs in the first planar side.

In some instances, the cutting of the counter-relief of the first face of the blank of the blade includes cutting a first cutting surface (e.g., first cutting surface 114(1)) of the blank of the blade a distance from a first non-cutting surface (e.g., first non-cutting surface 116(1)) of the blank of the blade. The first non-cutting surface of the blank of the blade may comprise the first planar side of the plate, and the first cutting surface of the blank of the blade may be cut a depth (e.g., depth 404(1)) below the first non-cutting surface of the blank of the blade.

In some instances, the cutting of the counter-relief of the first face of the blank of the blade includes cutting a bevel (e.g., bevel 118(1)) between the first cutting surface of the blank of the blade and the first non-cutting surface of the blank of the blade. In some instances, the cutting of the bevel comprises cutting a hollow bevel between the first cutting surface of the blank of the blade and the first non-cutting surface of the blank of the blade. In some instance, the cutting of the hollow bevel comprises cutting about a 16 degree hollow bevel between the first cutting surface of the blank of the blade and the first non-cutting surface of the blank of the blade. In another instance, the cutting of the bevel comprises cutting a flat bevel between the first cutting surface of the blank of the blade and the first non-cutting surface of the blank of the blade. In some instances, cutting the counter-relief of the first face of the blank of the blade comprises computer numerical control (CNC) machining the counter-relief of the first face of the blank of the blade. Subsequent to the cutting of the first counter-reliefs in the first planar side of the plate, the plate may be unmounted from the fixture and remounted on the fixture with the first planar side of the plate mounted on the fixture.

Next, process 500 proceeds to operation 504, which represents cutting a counter-relief (e.g., counter-relief 106(2)) of a second face of the blank of the blade (e.g., second face of the blank of the blade 108(2)) in the second planar side of the plate. The counter-relief of the second face of the blank of the blade may be cut in the second planar side of the plate symmetrically with the counter-relief of the first face of the blank of the blade in the first planar side of the plate. In some instances, the cutting of the counter-relief of the second face of the blank of the blade includes cutting a second cutting surface (e.g., second cutting surface 114(2)) of the blank of the blade a distance from a second non-cutting surface (e.g., second non-cutting surface 116(2)) of the blank of the blade. The second non-cutting surface of the blank of the blade may comprise the second planar side of the plate, and the second cutting surface of the blank of the blade may be cut a depth (e.g., depth 404(2)) below the second non-cutting surface of the blank of the blade.

In some instances, the cutting of the counter-relief of the second face of the blank of the blade includes cutting a bevel (e.g., bevel 118(2)) between the second cutting surface of the blank of the blade and the second non-cutting surface of the blank of the blade. In some instances, the cutting of the bevel comprises cutting a hollow bevel between the second cutting surface of the blank of the blade and the second non-cutting surface of the blank of the blade. In some instance, the cutting of the hollow bevel comprises cutting about a 16 degree hollow bevel between the second cutting surface of the blank of the blade and the second non-cutting surface of the blank of the blade. In another instance, the cutting of the bevel comprises cutting a flat bevel between the second cutting surface of the blank of the blade and the second non-cutting surface of the blank of the blade. In some instances, cutting the counter-relief of the second face of the blank of the blade comprises computer numerical control (CNC) machining the counter-relief of the second face of the blank of the blade.

Next, process 500 proceeds to operation 506, which represents removing the blank of the blade from the plate. In some instances, removing the blank of the blade from the plate comprises water jet cutting (e.g., computer numerical control (CNC) water jet cutting) the blank of the blade from the plate. In some instances, removing the blank of the blade from the plate comprises electric discharge machining (EDM) the blank of the blade from the plate, stamping the blank of the blade from the plate, or computer numerical control (CNC) machining the blank of the blade from the plate.

Process 500 may be completed at operation 508, which represents finishing the blank of the blade removed from the plate. In some instances, finishing the blank of the blade comprises removing cosmetic machine marks from the surfaces of the blank of the blades. In some instances, finishing the blank of the blade comprises sharpening the cutting portions of the blanks of the blades. Operation 508 may further represent heat treating the blank of the blade prior to the sharpening of the blank of the blade. While operation 508 represents heat treating the blank of the blade subsequent to the blank of the blade being removed from the plate, in some instances, the plate may be heat treated subsequent to the cutting of the counter-reliefs in the plate, and prior to removing the blank of the blades from the plate.

The process 500 (as well as each process described herein) is illustrated as a logical flow graph, each operation of which represents a sequence of operations that can be implemented in hardware, software, or a combination thereof. In the context of software, the operations represent computer-executable instructions stored on one or more non-transitory computer-readable storage media that, when executed by one or more processors, perform one or more of the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the process. In some instances, one or more non-transitory computer-readable media storing computer-executable instructions, that when executed by an apparatus (e.g., computer numerical control (CNC) machine)), cause the apparatus to perform one or more of the recited operations.

### CONCLUSION

Although the invention has been described in language specific to structural features and/or methodological acts, it is to be understood that the invention is not necessarily limited to the specific features or acts described. Rather, the specific features and acts are disclosed as illustrative forms of implementing the invention. For example, while embodiments are described having certain shapes, sizes, and configurations, these shapes, sizes, and configurations are merely illustrative. For example, the shape, size, and configuration of the blanks of the blades may be varied.

What is claimed is:

1. A method comprising:
prior to removing a blank of a blade from a plate,
cutting a counter-relief of a first face of the blank of the blade in a first planar side of the plate opposite a second planar side of the plate;
cutting a counter-relief of a second face of the blank of the blade in the second planar side of the plate, and
wherein the counter-relief of the second face of the blank of the blade is cut in the second planar side of the plate symmetrically with the counter-relief of the first face of the blank of the blade in the first planar side of the plate.

2. The method of claim 1, wherein cutting the counter-reliefs of the first and second faces of the blank of the blade comprises computer numerical control (CNC) machining the counter-reliefs of the first and second faces of the blank of the blade.

3. The method of claim 1, the method further comprising removing the blank of the blade from the plate.

4. The method of claim 3, wherein removing the blank of the blade from the plate comprises water jet cutting the blank of the blade from the plate.

5. The method of claim 3, wherein removing the blank of the blade from the plate comprises electric discharge machining (EDM) the blank of the blade from the plate, stamping the blank of the blade from the plate, or computer numerical control (CNC) machining the blank of the blade from the plate.

6. The method of claim 1, wherein the cutting of the counter-relief of the first face of the blank of the blade comprises:
cutting a first cutting surface of the blank of the blade and a first non-cutting surface of the blank of the blade, the first non-cutting surface of the blank of the blade comprising the first planar side of the plate, and the first cutting surface of the blank of the blade cut a depth below the first non-cutting surface of the blank of the blade.

7. The method of claim 6, wherein the cutting of the counter-relief of the first face of the blank of the blade further comprises:
cutting a bevel between the first cutting surface of the blank of the blade and the first non-cutting surface of the blank of the blade.

8. The method of claim 7, wherein the cutting of the bevel comprises cutting a hollow bevel between the first cutting surface of the blank of the blade and the first non-cutting surface of the blank of the blade.

9. The method of claim 8, wherein the cutting of the hollow bevel comprises cutting about a 16 degree hollow bevel between the first cutting surface of the blank of the blade and the first non-cutting surface of the blank of the blade.

10. The method of claim 7, wherein the cutting of the bevel comprises cutting a flat bevel between the first cutting surface of the blank of the blade and the first non-cutting surface of the blank of the blade.

11. The method of claim 1, wherein the cutting of the counter-relief of the second face of the blank of the blade comprises:
cutting a second cutting surface of the blank of the blade and a second non-cutting surface of the blank of the blade, the second non-cutting surface of the blank of the blade comprising the second planar side of the plate, and the second cutting surface of the blank of the blade cut a depth below the second non-cutting surface of the blank of the blade.

12. The method of claim 11, wherein the cutting of the counter-relief of the second face of the blank of the blade further comprises:
cutting a bevel between the second cutting surface of the blank of the blade and the second non-cutting surface of the blank of the blade.

13. The method of claim 12, wherein the cutting of the bevel comprises cutting a hollow bevel between the second cutting surface of the blank of the blade and the second non-cutting surface of the blank of the blade.

14. The method of claim 13, wherein the cutting of the hollow bevel comprises cutting about a 16 degree hollow bevel between the second cutting surface of the blank of the blade and the second non-cutting surface of the blank of the blade.

15. The method of claim 12, wherein the cutting of the bevel comprises cutting a flat bevel between the second cutting surface of the blank of the blade and the second non-cutting surface of the blank of the blade.

16. The method of claim 1, wherein the plate comprises stainless steel.

17. One or more non-transitory computer-readable media storing computer-executable instructions, that when executed by an apparatus, cause the apparatus to perform the method of claim 1.

18. A blank of a blade comprising:
a plate having a first planar side opposite a second planar side;
a counter-relief of a first face of the blank of the blade cut in the first planar side of the plate;
a counter-relief of a second face of the blank of the blade cut in the second planar side of the plate, and
wherein the counter-relief of the first face of the blank of the blade is symmetric with the counter-relief of the second face of the blank of the blade.

19. The blank of a blade of claim 18, wherein each of the counter-reliefs of the first and second faces of the blank of the blade comprise a non-cutting surface and a cutting surface, and wherein:
the first non-cutting surface of the blank of the blade comprises the first planar side of the plate;
the second non-cutting surface of the blank of the blade comprises the second planar side of the plate;
the first cutting surface of the blank of the blade is cut a depth below the first non-cutting surface of the blank of the blade; and
the second cutting surface of the blank of the blade is cut a depth below the second non-cutting surface of the blank of the blade.

20. The blank of a blade of claim 19, wherein the counter-relief of the first face of the blank of the blade comprise a bevel arranged between the first non-cutting surface and the first cutting surface, and the counter-relief of the second face of the blank of the blade comprise a bevel arranged between the second non-cutting surface and the second cutting surface.

21. A blank of a blade comprising:
a first face comprising a first non-cutting surface of the blade and a first cutting surface of the blade, the first non-cutting surface of the blade comprising a first planar side of a plate of metal, and the first cutting surface of the blade cut a depth below the first non-cutting surface of the blade; and
a second face comprising a second non-cutting surface of the blade and a second cutting surface of the blade, the second non-cutting surface of the blade comprising a second planar side of the plate of metal, and the second cutting surface of the blade cut a depth below the second non-cutting surface of the blade.

22. The blank of the blade of claim 21, further comprising a bevel cut between the first non-cutting surface of the blade and the first cutting surface of the blade, and a bevel cut between the second non-cutting surface of the blade and the second cutting surface of the blade.

23. The blank of the blade of claim 21, wherein the bevel cut between the first non-cutting surface of the blade and the first cutting surface of the blade comprises a hollow bevel or a flat bevel, and the bevel cut between the second non-cutting surface of the blade and the second cutting surface of the blade comprises a hollow bevel or a flat bevel.
